(19) United States
(12) Patent Application Publication
(10) Pub. No.: US 2026/0135899 A1
(43) Pub. Date: May 14, 2026

(54) VIRTUAL OVERLAY NETWORK CREATED OVER A VIRTUAL PRIVATE NETWORK (VPN)

(71) Applicant: Connectify, Inc., Philadelphia, PA (US)

(72) Inventors: Brian Prodoehl, Plymouth Meeting, PA (US); Kevin Cunningham, Swarthmore, PA (US); Alexander Gizis, Philadelphia, PA (US)

(21) Appl. No.: 19/032,414

(22) Filed: Jan. 20, 2025

Related U.S. Application Data
(60) Provisional application No. 63/622,440, filed on Jan. 18, 2024.

(51) Int. Cl. H04L 65/80; H04L 12/46

(52) U.S. Cl. CPC H04L 65/80; H04L 12/4641

(57) ABSTRACT

One example process may include receiving, via a virtual private network (VPN) server, a communication from a client device among various client devices currently operating on a VPN, determining the client device communication is intended for one or more other of the client devices operating on a virtual overlay network managed by a data network management entity server operating on the VPN, determining, via the VPN server, the client device and the one or more other of the client devices are registered to the virtual overlay network, and forwarding, via the VPN server, the communication to one or more other VPN servers which are communicating with the one or more of other of the client devices.

### TECHNICAL FIELD

This application relates to virtual network configurations, and more specifically to managing virtual network services on a virtual private network (VPN).

### BACKGROUND

Conventionally, mobile devices may use a carrier data service and/or local area networks to communicate over the Internet. When a virtual private network (VPN) service is used by a user (client) device, such as a mobile device or other computing device, the network being used for data services may be monitored and managed by a VPN server to ensure the client device is using the network(s) designated by the VPN. The VPN may prioritize the Internet connection(s) based on how “expensive” and/or “optimal” those connections are when being used by the client device. This may be referred to as the “priority” of the connection(s). A client device may have multiple Wi-Fi networks available to use at any given time and may also have more than one cellular network and in some cases even a satellite network that is available to transfer and receive data.

A VPN server can establish a virtual network that is intended for use by certain members of the group. Any client device that is a member of this virtual network may be able to share information, access to peripheral devices and other resources with other client devices which are also members of the virtual network and the specific group. The virtual network can be created with its own IP address assignment scheme managed by the VPN server to ensure the network data is routed to members of the network directly and without unnecessary data routing through a cloud network or the Internet.

### SUMMARY

Example embodiments of the present application include a process which may include receiving, via a virtual private network (VPN) server, a communication from a client device among various client devices currently operating on a VPN, determining the client device communication is intended for one or more other of the client devices operating on a virtual overlay network managed by a data network management entity server operating on the VPN, determining, via the VPN server, the client device and the one or more other of the client devices are registered to the virtual overlay network, and forwarding, via the VPN server, the communication to one or more other VPN servers which are communicating with the one or more of other of the client devices.

Another example embodiment may include a method that includes receiving, via a virtual private network (VPN) server, a communication from a client device among a plurality of client devices registered on a virtual overlay network managed by a plurality of VPN servers, determining, via the VPN server, the communication is intended for one or more other of the plurality of client devices registered on the virtual overlay network, and forwarding, via the VPN server, the communication to another VPN server in communication with the one or more other of the plurality of client devices.

Another example embodiment may include a non-transitory computer readable storage medium configured to store instructions that when executed cause a processor to perform receiving, via a virtual private network (VPN) server, a communication from a client device among a plurality of client devices registered on a virtual overlay network managed by a plurality of VPN servers, determining, via the VPN server, the communication is intended for one or more other of the plurality of client devices registered on the virtual overlay network, and forwarding, via the VPN server, the communication to another VPN server in communication with the one or more other of the plurality of client devices.

Another example embodiment may include a system that includes a plurality of client devices, and a virtual private network (VPN) server configured to receive a communication from a client device among the plurality of client devices registered on a virtual overlay network managed by a plurality of VPN servers, determine the communication is intended for one or more other of the plurality of client devices registered on the virtual overlay network, and forward the communication to another VPN server in communication with the one or more other of the plurality of client devices.

### BRIEF DESCRIPTION OF THE DRAWINGS

FIG. 1 illustrates an example data session network configuration according to example embodiments.

FIG. 2A illustrates an example network configuration of a client devices being managed by various VPN servers according to example embodiments.

FIG. 2B illustrates an example network configuration of client devices being managed by various VPN servers and each client device being part of the same virtual network according to example embodiments.

FIG. 2C illustrates an example network configuration of client devices being managed by various VPN servers and some of the client devices being part of the same virtual network according to example embodiments.

FIG. 3 illustrates an example of a client device sharing a device with other client devices.

FIG. 4A illustrates a flow diagram of communication between a mobile device and a VPN server according to example embodiments.

FIG. 4B illustrates a flow diagram of communication between a mobile device and a VPN server according to example embodiments.

FIG. 5 illustrates an example network entity device configured to store instructions, software, and corresponding hardware for executing the same according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments may be referred to with reference to a communication ‘session’. The term session may be a communication data link between a client and server or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, multiple TCP/UDP sockets being created in a single session, etc., among other device resources being used in a session. Multiple transport connections which are established via TCP and/or UDP may also be considered a session. Additionally, encryption that is used for the session may be independently established to include a unique key for each transport connection and/or channel established for the session. The session encryption may instead by a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server may provide data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/Internet protocol and it is specifically designed as a model to offer reliable data byte streams over various interconnected data networks/WLANs. UDP is a datagram/packet-oriented protocol used for broadcast and multicast types of network transmissions.

TCP is a connection-oriented protocol and UDP is a connectionless protocol. The speeds associated with TCP are generally slower than UDP, while the speeds of UDP are generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segments.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also does not perform the same error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another. It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP is reliable as it guarantees delivery of data to the destination router. The delivery of data to the destination is not guaranteed by UDP. UDP is ideal to use with multimedia like voice over IP (VoIP) since minimizing delays is critical. TCP sockets should be used when both the client and the server independently send packets and an occasional delay is acceptable. UDP should be used if both the client and the server separately send packets, and an occasional delay is not acceptable.

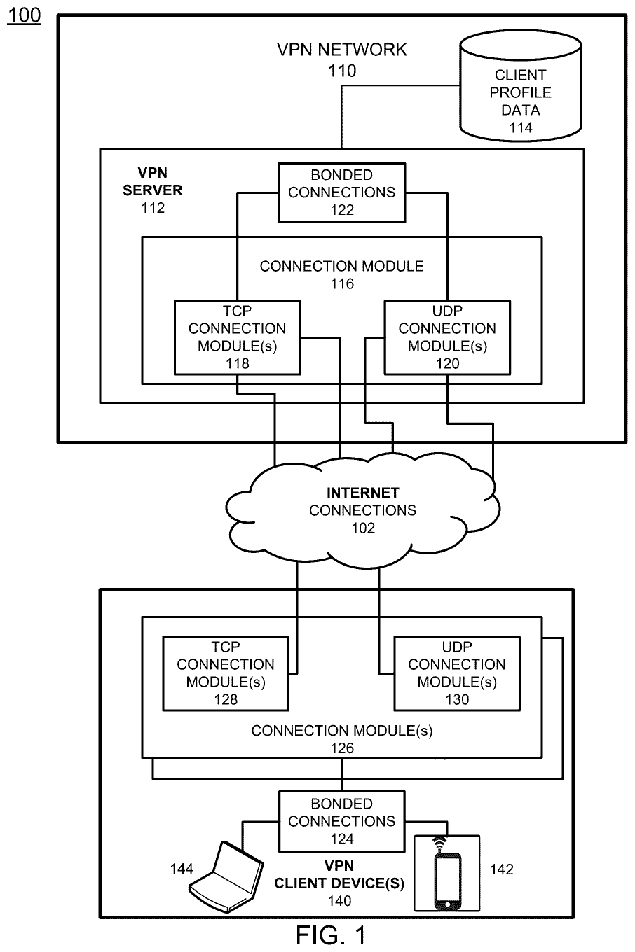

FIG. 1 illustrates an example data session network configuration according to example embodiments. Referring to FIG. 1, the configuration 100 may include a virtual private network (VPN) 110 which includes one or more VPN servers 112 and data storage, which in this example is used for storing client profile data 114 associated with one or more new or old client communication sessions. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transport connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

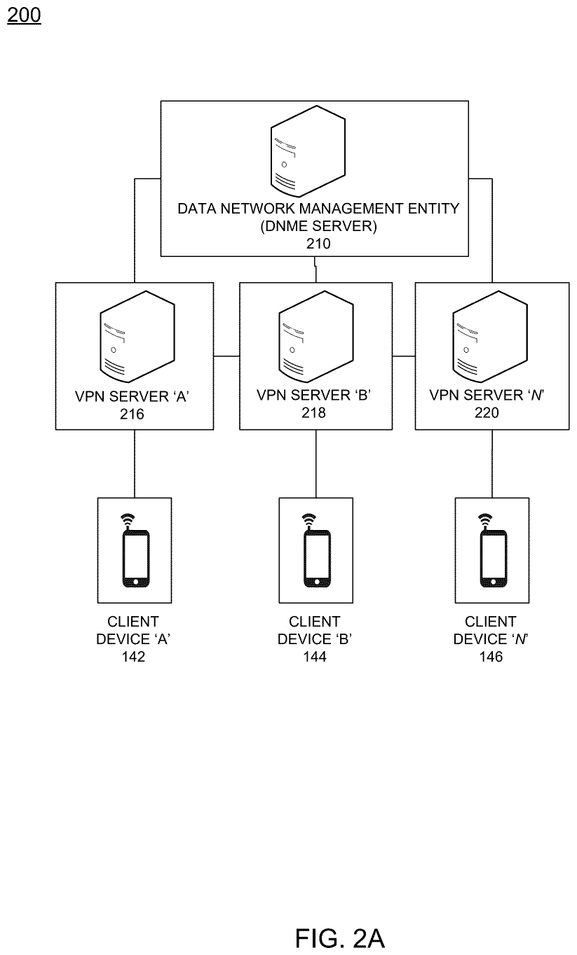

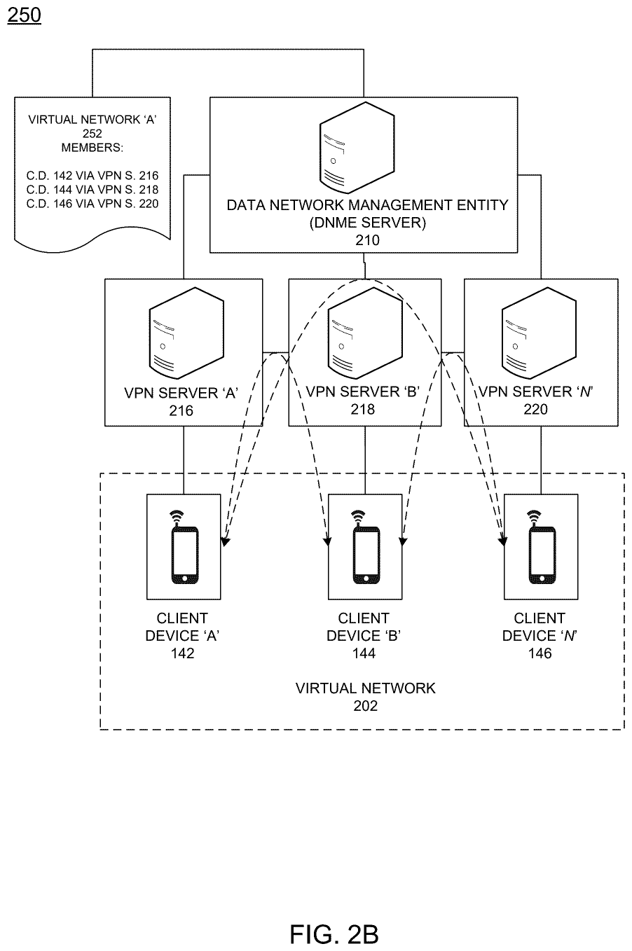

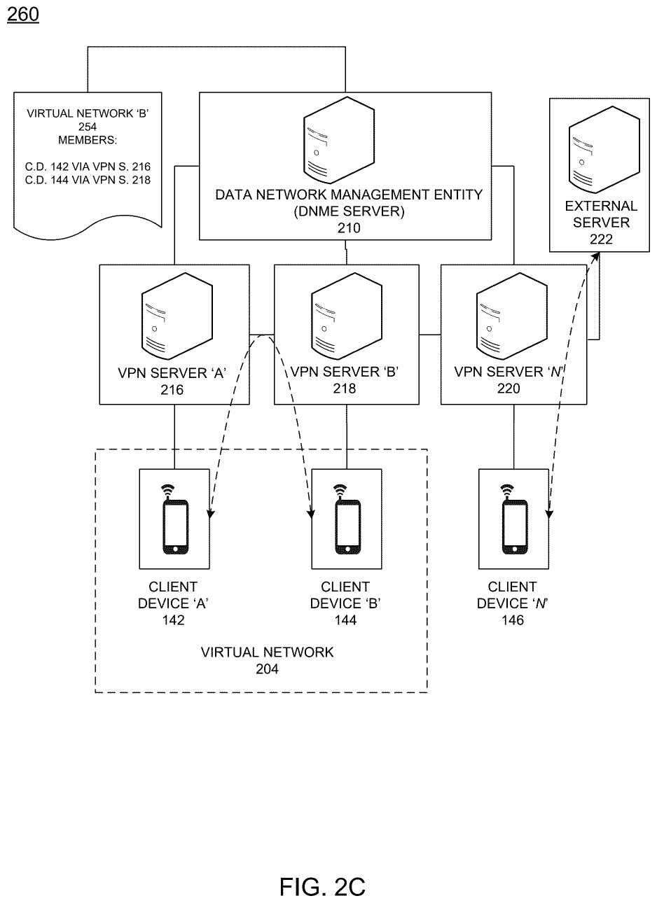

FIG. 2A illustrates an example network configuration of client devices being managed by various VPN servers according to example embodiments. Referring to FIG. 2A, the network configuration 200 demonstrates various client devices 142, 144 and 146 which may be connected to one or more VPN servers 216, 218 and 220 for data management purposes. In this example, each client device is currently utilizing a separate VPN server (e.g., 216, 218 and 220, respectively). The connections between the client devices and each VPN server may provide data routing and data management performed by the VPN servers. For example, data requests sent from the client devices may be sent directly to the respective VPN servers prior to the data request being sent to remote servers and corresponding data being retrieved from such remote entities (not shown), which is provided back to the requesting client device(s) via their respective VPN server. A client device, such as 142 may be attempting to receive streaming data from a content server in the cloud. The VPN server ‘A’ 216 may receive the request and forward the request to the content server and the results (retrieved data) are forwarded to the VPN server 216 and then forwarded from the VPN server 216 to the client device 142. This example of using a VPN server to manage data requests is one example service provided by the VPN server. Other examples may include an application specific virtual network being established by the various VPN servers since they are sharing a common network server for VPN service management purposes.

In one example, any client device that is part of a VPN server group may have access to other client devices via a central managing server (i.e., a lead VPN server). For purposes of this disclosure, the data network management entity (DNME) 210 will be the management server responsible for tracking the VPN servers 216-220 used on a common network along with the client devices 142-146. The DNME 210 may be responsible for designating the VPN servers as available for data management purposes, assigning names and IP addresses to each of the VPN servers and the client devices for internal network management purposes, and assigning each of the client devices 142-146 to a specific VPN server during a VPN application launch process. Application specific data management use purposes may provide a client device, such as 142 with an option to establish and/or participate in a private network for resource sharing purposes. Any participating client device using the VPN client application to connect to a VPN server may be invited to participate in the private network, which may be established as a virtual network among client devices and corresponding VPN servers to perform direct communication between the client devices over the VPN servers.

In one example, direct communication may be performed among the participating client devices which are connected to ‘dedicated speed’ servers (i.e., VPN servers) by using a secure overlay network (virtual network) established on the VPN server side of the network and managed by the VPN server assigned to a particular client device and/or a main VPN management server such as DNME 210. In operation, client devices from a same account, group and/or team of established accounts can be assigned to a virtual network, regardless of which VPN server they are connected to during a particular data session. In this example, the three devices 142-146 are part of a common virtual network 202 (See FIG. 2B) and are identified as being in communication with a particular VPN server as managed by the DNME 210. The client devices may be identified as candidates for the local direct communication (overlay) network. The client devices participating in the virtual network may be assigned an IP address scheme managed by the group and assigned to the one or more VPN servers and/or the DNME 210 that identifies the client devices on the virtual network and the VPN servers connected to the participating client devices.

The IP address assigned to a client device by the DNME 210 will provide a unique network address mapping for the local network. This local IP address is assigned to the client device and used by the VPN server operating in an active session with that same client device. The local IP address is used in addition to a global IP address assigned to the client device by a corresponding Internet service provider (ISP). The virtual network IP address identifies that the local network is available for all data sent by one client device, which is to be forwarded to another client device by VPN server to VPN server communication. In operation, an audit is continuously performed by each VPN server that has a knowledge base of a virtual network that exists at a particular time. Such information may be available in a table or other data source (i.e., document, see virtual network list 252 of FIG. 2B).

A virtual network may be established by the VPN server as a managed network that can be established for a single client device, multiple client devices, etc. A single client device may attempt to create the virtual network group by an application option provided by the VPN server ‘client’ software operating on the client device. The virtual ‘overlay’ network may be created by a single client device request sent to a VPN server to include itself and certain other client devices operating on the VPN entity network (i.e., any client device using the VPN service and connected to a VPN server). The other client devices may receive a request to join the overlay network as an internal network operating and identified on the VPN service managed by the DNME 210. The role of the DNME 210 is ideally just another VPN server that is managing the other VPN servers 216-220, however, the DNME 210 may be a server dedicated to storing information about the VPN servers, the client devices, and any other services, such as the virtual overlay network. Alternatively, the management of the virtual network overlay configuration may be performed by any VPN server on the network.

FIG. 2B illustrates an example network configuration 250 of client devices being managed by various VPN servers and each being part of the same virtual network according to example embodiments. Referring to FIG. 2B, the example includes a virtual overly network ‘A’ 252 having been created by the DNME 210 responsive to a request by a client device to create the network for internal and direct communication purposes. The DNME 210 is responsible for storing a knowledgebase of the virtual network members and any VPN server that can support the virtual network. The information may be stored in a list or table 252 and shared with the other VPN servers and client devices if necessary. Any data received from any client device 142-146 by any VPN server (216-220) that is registered to use a virtual overlay network and is destined for a registered entity of the ‘local’ virtual overly network will remain inside the VPN server's managed local network and will not be sent to an external network, any other data that includes data packets with a global IP address and no local IP address will be routed away from the VPN servers to a remote server over an Internet connection outside the VPN specific network. The VPN servers that receive data packets with internal IP destinations will attempt to forward the data to a corresponding VPN server based on the local IP addresses identified from the data packets.

In one example, a user of a client device may request to create a new virtual network, for either their account, or an existing team that is identified as part of their account, and can optionally assign the network a name, such as ‘company XYZ’. This virtual network information is stored in a database managed by the DNME 210 including information, such as which client device created the virtual network, when it was created, a unique identifier assigned to the network, the network name, and other information. During a login procedure, client devices are assigned a list of virtual networks they can join based on what is stored in the database managed by the DNME 210. The option to join those networks may be based on whether the client device is subscribed to a particular VPN server.

A user can select to connect to one or more of these virtual networks automatically as soon as the VPN server client application is connected to a VPN server that is associated with the virtual network. In order to connect to the virtual network, the client device forwards the virtual network information to a server process operating on a corresponding VPN server. The VPN server process verifies that the user is actually permitted to join that virtual network by invitation or name recognition of the virtual network information. The server process operating on the VPN server then launches another VPN process that will register itself with a database as an active member of that virtual network, identify any peers in that same virtual network, and establish secure, encrypted connectivity to the network members over the Internet if the network members are available to join.

The VPN servers can establish an IP based network to each of the network peers, over the secure, encrypted connections, using a new private IP subnet which assigns internal IP address information to each member and entity (i.e., peripheral device) belonging to the network. Once IP connectivity is established, then members of the virtual network can communicate with each other on that private IP subnet assigned to the network. Data traffic is routed to and from the VPN server(s), and the devices can communicate to IP-based services operating on any device of the network as part of this virtual network service. Joining the local network enables local communication between client device members and permits access to a port which may be used to access data stored in a folder, data that is being forwarded on an ongoing basis (e.g., a live camera feed) or any other data managed by the VPN server that is currently being used, shared, etc.

The VPN server will manage the flow of network data to any established groups and members participating in that group, an overlay network managed by the VPN server will provide network data between members of the virtual network where the data is obfuscated from client devices which would include different VPN servers. The VPN server will use IP address information, port information, and related data packet information that is limited to the VPN server managing the virtual network. This process would include one data network management entity (DNME) operating as the orchestrator of communications between at least two client devices. The various different client devices could be communicating directly to different respective VPN servers. However, one DNME 210 will appear as the only visible entity to the client devices regardless of which VPN server the client device is using. This visibility will include obfuscation of IP address information that is not assigned to the DNME 210. The client devices will use private IP addresses assigned by the DNME 210.

FIG. 2C illustrates an example network configuration 260 of client devices being managed by various VPN servers and some of the client devices being part of the same virtual network according to example embodiments. Referring to FIG. 2C, two client devices 142 and 144 are part of a common virtual network 204 and may share information directly via a common VPN server 216 to VPN server 218 communication. The network group ‘B’ 254 may include the two client devices 142 and 144 and may be logged as an active virtual private network group 204 in the DNME 210. The other VPN server 220 in this example may be providing another client device 146 with a VPN server service to an external server 222, however, this client device 146 may not be part of this active virtual network 204.

In one example, a client device may have various peripheral devices that are actively operating on a local network service that are desired to be accessed from anywhere on the Internet. A virtual host name can be assigned to a particular device operating with a VPN client application. When DNS requests for that host name are identified by the VPN servers, the request can be resolved for any HTTP or HTTPS requests to that host name. The requests would be forwarded through the VPN server to the intended device. A local domain may be used for port forwarding, for example, the DNS request may be intercepted and the local site may be retrieved and modified accordingly.

In operation, when a request to create a new virtual host name is received, the virtual host name is stored in a database identifying the entity that created the host name, when it was created, a unique identifier assigned to the host name, and which device it should be associated to at login. Client devices may receive a list of virtual host names associated with their current device that can be selected to enable or disable these virtual host names when a connection to the VPN server is performed. The client device may forward the virtual host name to the VPN server which verifies that the client device is permitted to use that virtual host name if the client device is identified on a list of client devices assigned to the host name (i.e., group), the VPN server informs the HTTPS reverse proxy to forward any incoming connections for that virtual host name to the client device. The sharing may be performed for a peripheral device. The virtual host name can be controlled by the client device, others can access the shared data if they have the virtual host name and are authorized to access the group. In this example, a single VPN client is communicating with the VPN server. Other devices can access this information which are not on operating on the VPN server since this shared resource is available to any device which has the group information.

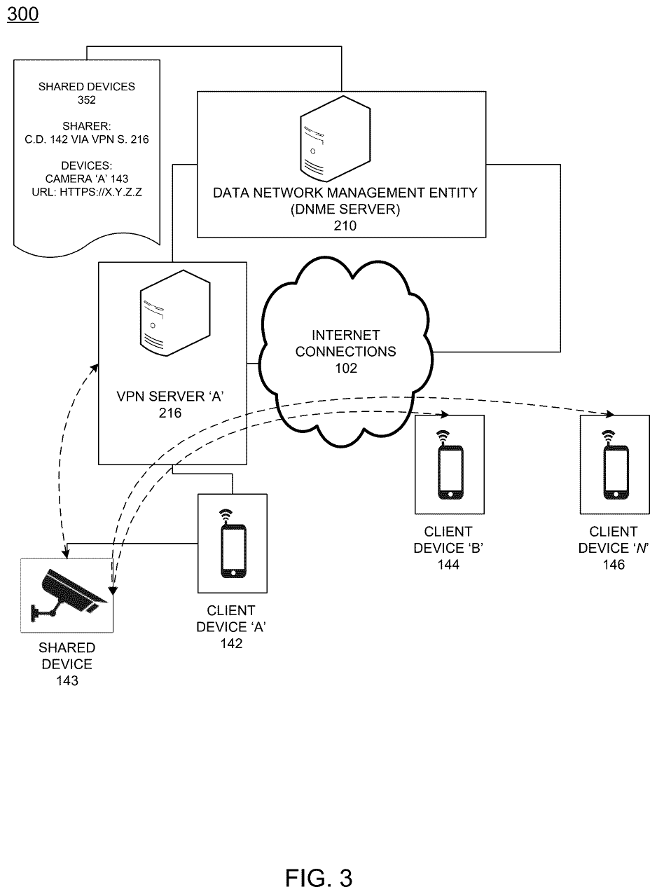

In one example 300, a client device ‘A’ may be attempting to share a network device and/or peripheral device, such as a camera 143 (see FIG. 3) so that other devices (144/146) can view the camera feed. Those other devices which are able to access the camera may or may not be clients of the VPN server 216 and/or any overlay network that is established. The client device ‘A’ may forward the share request to the VPN server 216 that it is assigned with and communicating with on a regular basis. The VPN server 216 notifies the managing device DNME 210 about the shared device 143. The DNME 210 creates a record for the shared device 143 by mapping an assigned internal IP address and web link (URL) to an Internet address. The shared devices 352 may be identified in a data file with the sharing device 142, the VPN server 216 and the URL of the device 143 being shared.

The camera 143 can have an assigned URL, such as a name registration, path name identifier, an internal IP address assigned to the device by the VPN network, and an external public IP address. The external IP address will be based on the VPN server IP address. The other client devices which have knowledge of this shared device 143, can then retrieve the data associated with the shared device 143, such as a live camera feed, by using the URL to resolve the VPN server 216 that is managing the client device and its shared device 143. Any device using the URL to access the shared device 143 can perform an access operation without authentication. Options for limiting access to the device may include a time limit, authentication by the VPN server (i.e., password, etc.). Using a VPN server can provide a secure way to share resources by a sharing device and to limit access to the shared device at any time. During an access operation by a client device, such as client device B that has knowledge of the URL of the shared device, the client device B sends a request to the VPN server ‘A’ 216. The URL address information is mapped to the internal IP address information of the shared device 143. The request is forwarded to the client device ‘A’. The client device ‘A’ 142 can then share its device if the shared device is connected to the client device, wirelessly or via a wired connection. In the event that the shared device is not actively connected to the client device ‘A’, the request received would be forwarded from client device ‘A’ to the shared device 143 or any other device that is managing the connection to the shared device 143. The VPN server may receive the request on a particular port ‘X’ and then will forward the request to the client device on a same or different port. The client device may use a different port to share the data of the shared device 143 rather than the port that is used to connect to the VPN server.

Bonding of two or more channels may occur when the client device has access to two or more channels which may be combined into a single connection. Assuming two or more channels are available, such as a first cellular channel and a second cellular channel, or a Wi-Fi channel acting as the second channel, then those channels may be both used to transmit and receive alternating data packets of a common packet stream. This approach to using bonded channels provides increased bandwidth, optimization of latency and jitter on the combined channels and other optimization techniques to optimize overall data performance. Bonding may be performed between two or more channels in response to an identified use of the overlay network and/or in response to a discontinued use of the overlay network depending on the configuration.

One example process may include determining the client device is operating a bonded connection comprising two or more bonded channels and the communication was received on a first channel of the two or more bonded channels. Another example may include determining, via another VPN server, the communication is intended for a registered member of the virtual overlay network, and transmitting the communication on a first channel of a bonded connection including two or more bonded channels associated with the other client device.

The overlay network may be accessed and utilized by any of the participating network nodes via one or more bonded channels. In one example, one or more client devices 142, 144, etc., may be part of a virtual network 204. As a first device, such as 142 initiates bonded channels use to communicate to other devices, the access to a remote server or network location may be performed by the bonded channels, such that a common stream of packets alternate from a first channel to one or more additional channels during a data transmission and/or receiving process. Data communications across the overlay network may be committed to a single channel to simplify the sharing of data between network devices of the virtual network 204. In one example, when client devices 142 shares data with client device 144 and both are identified as members of the virtual network 204. The VPN server 216 may attempt to transmit the data received from 142 either directly to client device 144 or to another VPN server 218 associated with client device 144 via one channel associated with client device 144. In this example, the client device 142 may have two bonded channels including channel “A” and channel “B”. Data intended for an external site outside of any virtual overlay network may use both channels simultaneously. Data intended for communications inclusive of devices registered in the virtual network 204 may use one dedicated channel, such as channel “A”, which may be a channel provided by the network already, such as a Wi-Fi data channel. The dedication of using one channel for overlay network transmitting and receive may enable a network device to continue to use the bonded channels for real time sensitive communications, such as conferencing, calling, data streaming, etc., while communicating to other network devices in a seamless and undetectable manner.

In another example, when a device on the overlay network is being used to provide data to one or more other members of the overlay network, then the available channels may be bonded to ensure any available connection is utilized to ensure data communication between the one or more devices on the overlay network. In one example, the shared device ‘camera’ 143 may be shared with other members of the overlay network. Once shared or activated, the device 143 may begin to provide a stream of data to any of the devices on the network that desire to receive the video or image content. As a result, a bonding operation may be enacted to use more than one channel to ensure data delivery occurs reliably and without data degradation and network failure. When a device, such as 143 comes online, the channel bonding may be automatically enacted by the VPN server 216. When a device, such as 144, 142 or 146 requests access to the device 143, a bonding operation may occur which attempts to bond two or more channels together to ensure the available channels are used to connect to the shared device 143 for reliable data communications.

In another example embodiment, when the VPN server and one or more of the client devices begin communicating, the process may include receiving, via the virtual private network (VPN) server, a communication from a client device among a plurality of client devices registered on a virtual overlay network managed by a plurality of VPN servers and determining, via the VPN server, the communication is intended for one or more other of the plurality of client devices registered on the virtual overlay network, and forwarding, via the VPN server, the communication to another VPN server in communication with the one or more other of the plurality of client devices. The process may also include determining the client device is operating to two or more data channels, and responsive to the communication being identified, bonding the two or more data channels to create a single communication connection between the client device and the VPN server. The process may also include receiving a request, at the VPN server, to access a shared device on the overlay network from one or more of the client devices, bonding two or more data channels to created a bonded connection between the client device and the VPN server to support communication with the shared device, and transmitting data associated with the shared device over the bonded connection to the one or more client devices.

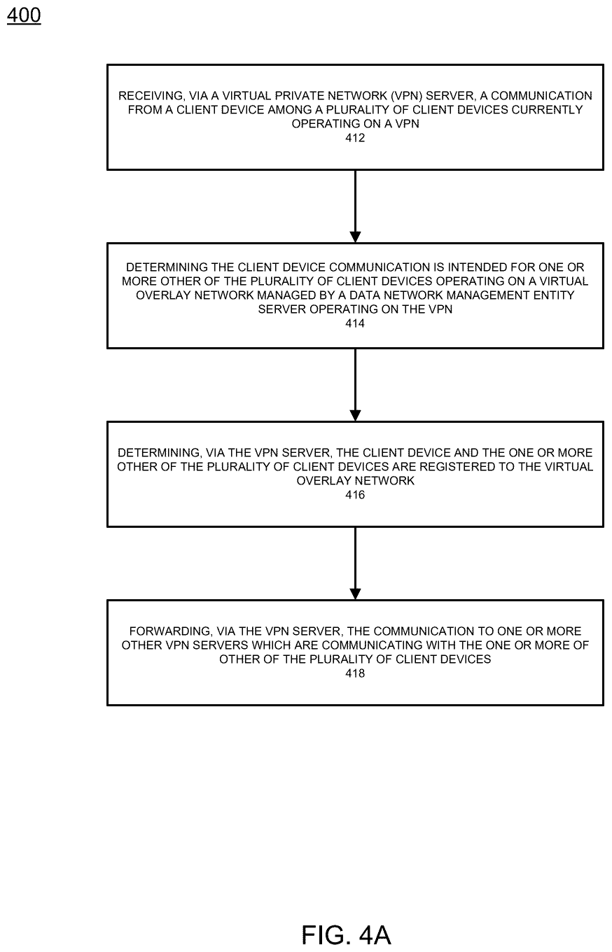

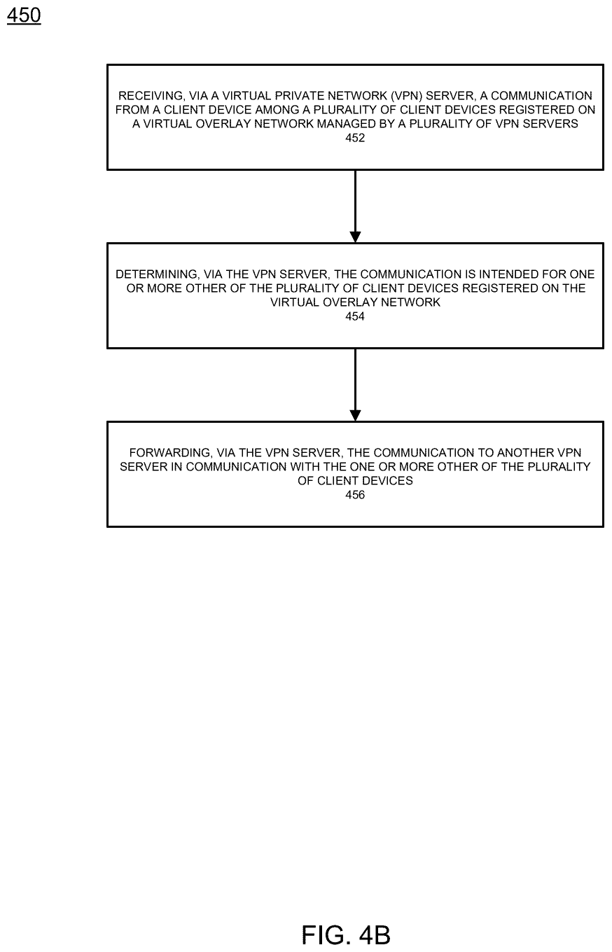

FIG. 4A illustrates a flow diagram of communication between a mobile device and a VPN server according to example embodiments. Referring to FIG. 4A, the example process 400 includes a mobile device receiving, via a virtual private network (VPN) server, a communication from a client device among a plurality of client devices currently operating on a VPN 412, determining the client device communication is intended for one or more other of the plurality of client devices operating on a virtual overlay network managed by a data network management entity server operating on the VPN 414, determining, via the VPN server, the client device and the one or more other of the plurality of client devices are registered to the virtual overlay network 416, and forwarding, via the VPN server, the communication to one or more other VPN servers which are communicating with the one or more of other of the plurality of client devices 418.

The forwarded communication may be transmitted by the VPN server via a direct channel between the VPN server and the one or more other VPN servers. The VPN servers operating on the VPN network are managed by data network management entity server. The data network management entity server is operating as a VPN server which stores profile information of the registered client devices operating as part of the virtual overlay network. mapping an internal IP address assigned to the client device as part of the virtual overlay network to an external IP address assigned to the client device. The communication may include a plurality of packets each including the internal IP address and the external IP address and including an internal IP address assigned to one or more of the other of the plurality of client devices. The process may also include mapping, via the VPN server, the internal IP address assigned to the one or more other of the plurality of client devices to one or more external IP address assigned to the one or more other of the plurality of client devices.

The DNME may have to provide the VPN server with an external IP address for the destination client device to provide a mapping of destination external IP to the destination internal IP address. The DNME can assign internal IP addresses for a period of time then they expire as the DNME discards the assignment table. Sharing a resource managed by a client device via a VPN server to other client devices may include receiving via a virtual private network (VPN) server a request from a client device to share a network resource, assigning, via the VPN server, a uniform resource locator (URL) to the shared network resource, receiving, via the VPN server, a request to access the URL from a remote client device, forwarding, via the VPN server, the request to the client device, and providing, via the VPN server, the shared network resource to the remote client device.

The assigned URL may be assigned to an IP address of the VPN server. The network resource may be one or more of a database, a camera, and a hard disk and may provide streaming media. The assigning the URL may include identifying a port on the client device and the VPN server and assigning the URL to an IP address and the port of the VPN server. The process may also include forwarding, via the VPN server, shared network resource information to a data network management server, which stores a record of the shared network resource.

FIG. 4B illustrates another example process 450. The example process may include receiving, via a virtual private network (VPN) server, a communication from a client device among a plurality of client devices registered on a virtual overlay network managed by a plurality of VPN servers 452, determining, via the VPN server, the communication is intended for one or more other of the plurality of client devices registered on the virtual overlay network 454, and forwarding, via the VPN server, the communication to another VPN server in communication with the one or more other of the plurality of client devices 456. In one example, the forwarded communication is transmitted by the VPN server via a direct channel between the VPN server and the another VPN server without using a router or other network device requiring access to the Internet. The plurality of VPN servers operating on the virtual overlay network may be managed by a data network management entity server which maintains a list of the client devices registered on the overlay network. The data network management entity server is operating as one of the plurality of VPN servers which stores profile information of the registered plurality of client devices operating as part of the virtual overlay network. The process may also include mapping an internal IP address assigned to the client device as part of the virtual overlay network to an external IP address assigned to the client device. The communication may include a plurality of packets each including the internal IP address and the external IP address and including an internal IP address assigned to one or more of the other of the plurality of client devices. The process may also include mapping, via the VPN server, the internal IP address assigned to the one or more other of the plurality of client devices to one or more external IP address assigned to the one or more other of the plurality of client devices. The process may also include establishing, via the VPN server, a live feed to a camera communicably coupled to the client device with the another VPN server, and providing the live feed to the one or more other of the plurality of client devices, and receiving, via the VPN server, an additional communication from the client device intended for a remote server outside the overlay network, and forwarding, via the VPN server, the additional communication using an external IP address assigned to the client device.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

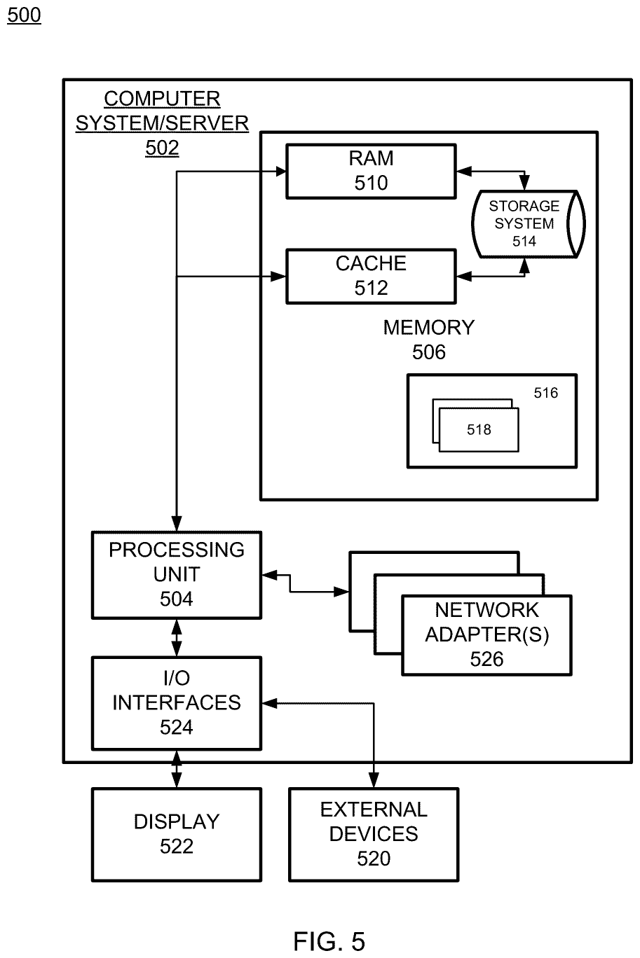

FIG. 5 illustrates an example network entity device configured to store instructions, software, and corresponding hardware for executing the same according to example embodiments. FIG. 5 is not intended to suggest any limitation as to the scope of use or functionality of embodiments of the application described herein. Regardless, the computing node 500 is capable of being implemented and/or performing any of the functionality set forth hereinabove.

In computing node 500 there is a computer system/server 502, which is operational with numerous other general purpose or special purpose computing system environments or configurations. Examples of well-known computing systems, environments, and/or configurations that may be suitable for use with computer system/server 502 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 5, computer system/server 502 in cloud computing node 500 is displayed in the form of a general-purpose computing device. The components of computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media. System memory 506, in one embodiment, implements the flow diagrams of the other figures. The system memory 506 can include computer system readable media in the form of volatile memory, such as random-access memory (RAM) 510 and/or cache memory 512. Computer system/server 502 may further include other removable/non-removable, volatile/non-volatile computer system storage media. By way of example only, storage system 514 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 506 may include at least one program product having a set (e.g., at least one) of program modules that are configured to carry out the functions of various embodiments of the application.

Program/utility 516, having a set (at least one) of program modules 518, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules 518 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 502 may also communicate with one or more external devices 520 such as a keyboard, a pointing device, a display 522, etc.; one or more devices that enable a user to interact with computer system/server 502; and/or any devices (e.g., network card, modem, etc.) that enable computer system/server 502 to communicate with one or more other computing devices. Such communication can occur via I/O interfaces 524. Still yet, computer system/server 502 can communicate with one or more networks such as a local area network (LAN), a general wide area network (WAN), and/or a public network (e.g., the Internet) via network adapter(s) 526. As depicted, network adapter(s) 426 communicates with the other components of computer system/server 502 via a bus. It should be understood that although not displayed, other hardware and/or software components could be used in conjunction with computer system/server 502. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
receiving, via a virtual private network (VPN) server, a communication from a client device among a plurality of client devices registered on a virtual overlay network managed by a plurality of VPN servers;
determining, via the VPN server, the communication is intended for one or more other of the plurality of client devices registered on the virtual overlay network; and
forwarding, via the VPN server, the communication to another VPN server in communication with the one or more other of the plurality of client devices.

2. The method of claim 1, comprising:
determining the client device is operating to two or more data channels; and
responsive to the communication being identified, bonding the two or more data channels to create a bonded connection between the client device and the VPN server.

3. The method of claim 1, comprising
receiving a request, at the VPN server, to access a shared device on the overlay network from one or more of the client devices;
bonding two or more data channels to created a bonded connection between the client device and the VPN server to support communication with the shared device; and
transmitting data associated with the shared device over the bonded connection to the one or more client devices.

4. The method of claim 1, wherein the forwarded communication is transmitted by the VPN server via a direct channel between the VPN server and the another VPN server.

5. The method of claim 1, wherein all the VPN servers operating on the virtual overlay network are managed by a data network management entity server which maintains a list of the client devices registered on the overlay network, and wherein the data network management entity server stores profile information of the registered plurality of client devices operating as part of the virtual overlay network.

6. The method of claim 1, comprising
mapping an internal IP address assigned to the client device as part of the virtual overlay network to an external IP address assigned to the client device.

7. The method of claim 6, wherein the communication comprises a plurality of packets each including the internal IP address and the external IP address and including an internal IP address assigned to one or more of the other of the plurality of client devices.

8. The method of claim 7, comprising
mapping, via the VPN server, the internal IP address assigned to the one or more other of the plurality of client devices to one or more external IP address assigned to the one or more other of the plurality of client devices.

9. The method of claim 1, comprising
establishing, via the VPN server, a live feed to a camera communicably coupled to the client device with the another VPN server; and
providing the live feed to the one or more other of the plurality of client devices.

10. The method of claim 1, comprising
receiving, via the VPN server, an additional communication from the client device intended for a remote server outside the overlay network; and
forwarding, via the VPN server, the additional communication using an external IP address assigned to the client device.

11. A non-transitory computer readable storage medium configured to store instructions that when executed cause a processor to perform:
receiving, via a virtual private network (VPN) server, a communication from a client device among a plurality of client devices registered on a virtual overlay network managed by a plurality of VPN servers;
determining, via the VPN server, the communication is intended for one or more other of the plurality of client devices registered on the virtual overlay network; and
forwarding, via the VPN server, the communication to another VPN server in communication with the one or more other of the plurality of client devices.

12. The non-transitory computer readable storage medium of claim 11, wherein the processor is further configured to perform:
determining the client device is operating to two or more data channels; and
responsive to the communication being identified, bonding the two or more data channels to create a bonded connection between the client device and the VPN server.

13. The non-transitory computer readable storage medium of claim 11, wherein the processor is further configured to perform:
receiving a request, at the VPN server, to access a shared device on the overlay network from one or more of the client devices;
bonding two or more data channels to created a bonded connection between the client device and the VPN server to support communication with the shared device; and
transmitting data associated with the shared device over the bonded connection to the one or more client devices.

14. The non-transitory computer readable storage medium of claim 11, wherein the forwarded communication is transmitted by the VPN server via a direct channel between the VPN server and the another VPN server.

15. The non-transitory computer readable storage medium of claim 11, wherein all the VPN servers operating on the virtual overlay network are managed by a data network management entity server which maintains a list of the client devices registered on the overlay network, and wherein the data network management entity server stores profile information of the registered plurality of client devices operating as part of the virtual overlay network.

16. The non-transitory computer readable storage medium of claim 11, wherein the processor is further configured to perform:
mapping an internal IP address assigned to the client device as part of the virtual overlay network to an external IP address assigned to the client device.

17. The non-transitory computer readable storage medium of claim 16, wherein the communication comprises a plurality of packets each including the internal IP address and the external IP address and including an internal IP address assigned to one or more of the other of the plurality of client devices.

18. A system comprising:
a virtual private network (VPN) server configured to
receive a communication from a client device among a plurality of client devices registered on a virtual overlay network managed by a plurality of VPN servers;
determine the communication is intended for one or more other of the plurality of client devices registered on the virtual overlay network; and
forward the communication to another VPN server in communication with the one or more other of the plurality of client devices.

19. The system of claim 18, wherein the VPN server is configured to
determine the client device is operating to two or more data channels; and
responsive to the communication being identified, bond the two or more data channels to create a bonded connection between the client device and the VPN server.

20. The system of claim 18, wherein the VPN server is configured to
receive a request to access a shared device on the overlay network from one or more of the client devices;
bond two or more data channels to created a bonded connection between the client device and the VPN server to support communication with the shared device; and
transmit data associated with the shared device over the bonded connection to the one or more client devices.
